(19) United States
(12) Patent Application Publication
(10) Pub. No.: US 2026/0352141 A1
(43) Pub. Date: Nov. 5, 2026

(54) PHOTOVOLTAIC ROOFING APPARATUS

(71) Applicant: Douglas Leman, Vero Beach, FL (US)

(72) Inventor: Douglas Leman, Vero Beach, FL (US)

(21) Appl. No.: 19/695,637

(22) Filed: Jun. 2, 2026

Related U.S. Application Data
(63) Continuation-in-part of application No. 19/193,696, filed on Apr. 29, 2025.
Application No. 19/193,696 is a continuation-in-part of application No. 18/811,629, filed on Aug. 21, 2024, now Pat. No. 12,658,842.
(60) Provisional application No. 63/604,020, filed on Nov. 29, 2023.

(51) Int. Cl. H02S 20/25; H02S 30/10; H02S 40/10; H02S 40/34; H02S 40/36

(52) U.S. Cl. CPC H02S 20/25; H02S 30/10; H02S 40/10; H02S 40/34; H02S 40/36

(57) ABSTRACT

A photovoltaic roofing apparatus includes a photovoltaic laminate supported by a unitary support structure. The support structure includes structural bonding lands configured to receive an adhesive bonding material between the support structure and the photovoltaic laminate. One or more depth gauges extend from the support structure to maintain a predetermined spacing between the photovoltaic laminate and the support structure while the adhesive bonding material is compressed therebetween. An edge seal region extends along at least a portion of a perimeter of the photovoltaic laminate and is configured to receive a sealant separate from the adhesive bonding material. At least one weep hole permits water entering past the edge seal region to drain from the support structure. The apparatus may further include a removable access panel with slotted mounting features, molded-in-place glass anchors, and an eave closure having centering notches and weep holes for drainage and installation alignment.

### CLAIM OF PRIORITY

This application is a Continuation-In-Part (CIP) of U.S. Non-Provisional patent application Ser. No. 19/193,696, filed on Apr. 29, 2025, which is a Continuation-In-Part (CIP) of U.S. Non-Provisional patent application Ser. No. 18/811,629, filed on Aug. 21, 2024, which in turn claims the benefit of U.S. Provisional Patent Application Ser. No. 63/604,020, filed on Nov. 29, 2023, all of which are incorporated by reference herein in their entireties.

### BACKGROUND OF THE INVENTION

### Field of the Invention

The present invention relates to photovoltaic roofing systems, and more particularly to a photovoltaic roofing apparatus incorporating structural and functional enhancements to improve attachment, installation, shipping, serviceability, and integration with a range of solar technologies.

### DESCRIPTION OF THE RELATED ART

Solar roof tiles, also known as photovoltaic tiles, are an increasingly popular solution for integrating solar energy generation into building structures. These tiles typically consist of a glass “sandwich” or “laminate,” which includes layers of glass, ethylene-vinyl acetate (EVA) foil, silicon wafers, EVA foil, and a back sheet. Additionally, these tiles require a junction box and a fastening structure to secure them to the roof. Existing solar roof tiles in the market vary in their attachment methods and structural compositions, each presenting unique challenges and limitations.

Various existing products utilize multiple materials and components such as rubber, aluminum clips, brackets, and grids for fastening and ventilation. These components are individually attached to the back of the glass sandwich, making the installation process labor-intensive and complex. Some systems employ intricate bracket systems that are difficult for installers to manage, while others use bases that are unsuitable for specific environments. Additionally, some products do not incorporate any structural support on the rear of their solar tiles, further complicating installation and reducing durability.

The attachment methods of existing solar roof tiles present significant challenges. The multi-component fastening systems, often involving several different materials, require extensive labor and precision during installation. This complexity can lead to increased costs and longer installation times. Additionally, the need for multiple suppliers for different components can complicate the supply chain, potentially leading to delays and inconsistencies in product quality. The coordination required to source and assemble these components from various suppliers can create logistical challenges, further complicating the installation process.

Fire resistance is another concern for photovoltaic roofing systems. Many current products use materials that, while functional, may not offer the best fire-resistant properties. Effective fire resistance is crucial to prevent the spread of fire through the roof structure, especially in areas prone to wildfires or other fire hazards. The ability to allow sufficient airflow for cooling while deterring fire spread is an important consideration in the design of solar roof tiles. The materials used in some existing products can reach their melting point under high temperatures, potentially leading to fire hazards if the roofing system does not adequately contain and dissipate heat.

Integration with existing roofing materials is also a significant factor. Most homes do not require full solar coverage, and the tempered glass used in solar tiles cannot be cut to fit specific dimensions. This necessitates the use of passive tiles made from different materials to cover the remaining roof areas. Ensuring a seamless blend between solar and passive tiles is important for aesthetic and functional reasons. A well-integrated roofing system must maintain a uniform appearance while also ensuring that both solar and non-solar tiles perform their respective functions effectively.

Another common issue with current solar roof tiles is their rigidity and inability to adjust to different roof shapes and sizes. The lack of flexibility in construction methods can limit the applicability of solar roof tiles to various building designs and geographical locations. Products that can be mounted directly to plywood or on elevated batten/counter batten systems offer greater adaptability and ease of installation in diverse construction scenarios. This flexibility is particularly important in regions with varied architectural styles and construction practices, where a one-size-fits-all approach is not feasible.

Wind resistance and the ability to withstand environmental factors such as rain and snow are also vital for solar roof tiles. The structural design must ensure that tiles remain securely attached under various weather conditions without causing damage or requiring frequent maintenance. The integration of ventilation systems that prevent direct airflow while allowing sufficient cooling is crucial for maintaining the efficiency and longevity of the solar cells. Proper ventilation helps prevent overheating of the solar cells, which can reduce their efficiency and lifespan. Moreover, the roofing system must be able to withstand strong winds and heavy precipitation without becoming dislodged or damaged.

In addition to these technical challenges, there are also practical considerations related to the installation and maintenance of solar roof tiles. The installation process must be straightforward enough for contractors to complete efficiently, yet robust enough to ensure long-term durability and performance. Maintenance is another important aspect, as solar roof tiles must be accessible for inspection, cleaning, and repair. Easy access to the tiles and their components can significantly reduce maintenance costs and downtime, ensuring that the roofing system remains functional and efficient over its lifetime.

In summary, while solar roof tiles offer a promising solution for renewable energy integration, they face several challenges related to installation complexity, fire resistance, material integration, structural flexibility, environmental durability, and practical maintenance. Addressing these issues is important to improving the efficiency, safety, and overall adoption of photovoltaic roofing systems in residential and commercial buildings. The development of innovative solutions that streamline installation, enhance fire resistance, seamlessly integrate with existing roofing materials, provide structural flexibility, and withstand environmental factors will play a crucial role in advancing the adoption of solar roof tiles.

### SUMMARY OF THE INVENTION

The present invention relates to an improved photovoltaic roofing apparatus incorporating structural and functional features that enhance bonding, sealing, drainage, impact resistance, serviceability, and installation alignment. In particular, the apparatus includes a unitary support structure configured to support a photovoltaic laminate and having structural bonding lands configured to receive an adhesive bonding material between the support structure and the photovoltaic laminate. The support structure may further include one or more depth gauges configured to control spacing between the photovoltaic laminate and the support structure, thereby maintaining a desired adhesive thickness and providing localized support against direct impacts. An edge seal region may extend along at least a portion of the perimeter of the photovoltaic laminate and may be configured to receive a sealant separate from the adhesive bonding material, thereby distinguishing structural bonding from environmental sealing. The apparatus may further include one or more weep holes configured to drain water that enters past the edge seal region, as well as a serviceable access tile having a removable access panel with slotted mounting features. In some embodiments, the apparatus may also cooperate with a self-aligning eave closure having centering notches and weep holes for alignment, starter-bracket placement, and drainage management during installation.

The present invention offers significant advantages over prior solar roofing systems by introducing structural and functional enhancements that address laminate bonding, moisture control, impact loading, service access, and installation consistency. The use of adhesive bonding material along defined structural bonding lands allows the photovoltaic laminate to be secured to the support structure through a distributed load path, while depth gauges help maintain proper adhesive thickness and reduce excessive compression during assembly. The separation of the structural bonding regions from the edge seal region allows the adhesive bonding material to provide retention while the sealant provides a perimeter environmental barrier. Weep holes provide a drainage path for water that may pass beyond the edge seal, thereby reducing trapped moisture and improving long-term durability of the roofing apparatus. A slotted removable access panel improves serviceability by allowing access to internal components without requiring removal of the entire photovoltaic roofing apparatus from the roof. In addition, a self-aligning eave closure with centering notches may simplify layout of tile rows and improve installation accuracy using fewer measurements. Overall, this improved photovoltaic roofing apparatus delivers a more durable, serviceable, moisture-managed, and installation-friendly solution for integrating solar energy technologies into both new and existing building structures.

In a first implementation of the present invention, a photovoltaic roofing apparatus is provided comprising a photovoltaic tile including a photovoltaic laminate, and a unitary support structure configured to support the photovoltaic tile. The unitary support structure comprises a support frame defining a laminate-receiving region configured to receive the photovoltaic laminate, and a plurality of structural bonding lands disposed along the support frame and configured to receive an adhesive bonding material between the support frame and the photovoltaic laminate. The unitary support structure further includes one or more depth gauges extending from the support frame within the laminate-receiving region, the one or more depth gauges being configured to maintain a predetermined spacing between the photovoltaic laminate and the support frame while the adhesive bonding material is compressed therebetween. An edge seal region extends along at least a portion of a perimeter of the photovoltaic laminate and is configured to receive a sealant separate from the adhesive bonding material. At least one weep hole is formed through a portion of the support frame and is positioned to permit water entering past the edge seal region to drain from the unitary support structure. The adhesive bonding material, the one or more depth gauges, the edge seal region, and the at least one weep hole cooperate to secure the photovoltaic laminate to the support frame while controlling adhesive thickness and providing a drainage path for water intrusion.

In a second aspect, wherein the adhesive bonding material may comprise a double-sided structural adhesive tape positioned along the plurality of structural bonding lands.

In another aspect, wherein the double-sided structural adhesive tape may extend along crossmember stitch zones of the support frame to provide additional bonding support beneath the photovoltaic laminate.

In another aspect, wherein the one or more depth gauges may comprise raised molded bosses, ribs, or stand-off structures configured to maintain uniform adhesive thickness between the photovoltaic laminate and the support frame.

In another aspect, wherein the one or more depth gauges may be further configured to cushion direct impacts applied to the photovoltaic laminate.

In another aspect, wherein the edge seal region may be positioned outwardly from the plurality of structural bonding lands such that the sealant is physically separated from the adhesive bonding material.

In another aspect, wherein the edge seal region may be configured to receive a silicone sealant extending continuously around a perimeter of the photovoltaic laminate.

In another aspect, wherein the at least one weep hole may be positioned along a lower portion of the unitary support structure to permit gravity-assisted drainage of water entering past the edge seal region.

In another aspect, wherein the at least one weep hole may be aligned with an eave closure configured to space starter brackets relative to the unitary support structure.

In another aspect, wherein the unitary support structure may further comprise an eave closure including one or more centering notches configured to align the photovoltaic roofing apparatus relative to a roof centerline.

In another aspect, wherein the one or more centering notches may be spaced such that adjacent rows of photovoltaic roofing apparatuses may be centered in alternating alignment patterns.

In another aspect, wherein the photovoltaic laminate may be secured within the support frame by one or more glass anchors molded in place within the unitary support structure.

In another aspect, wherein the one or more glass anchors may be fixed within the unitary support structure during formation of the support frame and may be configured to retain the photovoltaic laminate without sliding insertion.

In another aspect, wherein the photovoltaic roofing apparatus may further comprise an access tile including a removable access panel configured to provide access to an internal cavity of the unitary support structure.

In another aspect, wherein the removable access panel may comprise one or more slots configured to permit the access panel to be loosened and slid relative to the unitary support structure without complete removal of associated fasteners.

In another aspect, wherein the removable access panel may be secured by threaded fasteners extending through the one or more slots into the unitary support structure.

In another aspect, wherein the photovoltaic laminate may comprise a laminate selected from monocrystalline silicon, polycrystalline silicon, thin-film, or perovskite photovoltaic technologies.

In another aspect, wherein the unitary support structure may be configured to support photovoltaic laminates having different thicknesses and material compositions.

In another implementation of the present invention, a roofing alignment system for a photovoltaic roofing installation is provided comprising an eave closure configured to be positioned along a lower edge of a roofing substrate. The eave closure comprises a plurality of weep holes formed through the eave closure and spaced along a length of the eave closure to permit drainage from photovoltaic roofing apparatuses positioned above the eave closure. The eave closure further includes a plurality of starter-bracket locating regions disposed along the eave closure and positioned relative to the plurality of weep holes to guide placement of starter brackets adjacent to, and spaced from, the plurality of weep holes. The eave closure also includes one or more centering notches formed along the eave closure and configured to align at least one photovoltaic roofing apparatus relative to a centerline of a roof. The plurality of weep holes, the plurality of starter-bracket locating regions, and the one or more centering notches cooperate to provide drainage, starter-bracket placement, and row-centering alignment during installation of the photovoltaic roofing apparatuses.

In another implementation of the present invention, a serviceable photovoltaic roofing apparatus is provided comprising a photovoltaic tile including a photovoltaic laminate, and a unitary support structure configured to support the photovoltaic tile. The unitary support structure defines an internal cavity beneath the photovoltaic laminate. An access tile comprising a removable access panel is configured to cover at least a portion of the internal cavity. A plurality of fastener openings is formed in the unitary support structure, and a plurality of slots is formed in the removable access panel and configured to receive fasteners aligned with the plurality of fastener openings. A plurality of fasteners extends through the plurality of slots and into the plurality of fastener openings to removably secure the removable access panel to the unitary support structure. The plurality of slots are configured to permit the removable access panel to slide relative to the unitary support structure after the plurality of fasteners are loosened, thereby allowing the removable access panel to be removed from the unitary support structure to provide service access to the internal cavity.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a bottom view of the photovoltaic roofing apparatus, illustrating the layout of the structural components and the interlocking features of the unitary support structure;

FIG. 2 presents a leading edge view of the photovoltaic roofing apparatus, showing the ventilation system and the profile of the unitary support structure;

FIG. 3 presents an isometric view of the photovoltaic roofing apparatus, illustrating the overall structure, the interlocking features, and the ventilation system in relation to the unitary support structure;

FIG. 4 presents an alternative isometric view of the photovoltaic roofing apparatus, highlighting the cross-bracing and the edge protection features of the unitary support structure;

FIG. 5 presents a side view of the photovoltaic roofing apparatus, illustrating the profile of the unitary support structure and the arrangement of the fastening mechanism;

FIG. 6 presents a front view of multiple photovoltaic roofing apparatuses arranged in a stacked configuration, illustrating the modularity and scalability of the unitary support structures when installed on a roofing substrate;

FIG. 7 presents a side view of the photovoltaic roofing apparatus installed on a sloped roofing substrate, illustrating the engagement of the fastening mechanism and the alignment of the unitary support structure with the roof pitch;

FIG. 8 presents an isometric view of the top of the photovoltaic roofing apparatus, illustrating the support framework, fastening points, and the ventilation features of the unitary support structure;

FIG. 9 presents a top view of the photovoltaic roofing apparatus, illustrating optional nailing fins extending from the upper edge of the unitary support structure, a crossmember spanning the width of the frame, and a series of access insert holes positioned to receive fasteners for securing a removable access insert;

FIG. 10 presents a bottom view of the photovoltaic roofing apparatus, illustrating notches formed in a crossmember of the unitary support structure, the notches being configured to accommodate folded wires during shipping to prevent damage and facilitate compact packing;

FIG. 11 presents a left side view of the photovoltaic roofing apparatus, illustrating the profile of the unitary support structure and the positioning of an optional nailing fin extending upward from the top edge of the frame for use with conventional roofing nails;

FIG. 12 presents an isometric view of the photovoltaic roofing apparatus, illustrating the integration of optional nailing fins and reinforcing braces along the upper edge of the unitary support structure to enhance the strength and rigidity of the nailing interface;

FIG. 13 presents a rear isometric view of the photovoltaic roofing apparatus, illustrating a top crossmember extending across the upper portion of the unitary support structure, the top crossmember being configured to absorb upward forces from overlapping tiles and distribute loads to reduce stress on adhesive joints;

FIG. 14 presents a bottom isometric view of the photovoltaic roofing apparatus, illustrating a series of access insert holes positioned within the frame for receiving mechanical fasteners to secure a removable access insert, allowing maintenance access to underlying components or electronics;

FIG. 15 presents an isometric view of the photovoltaic roofing apparatus with the access insert partially removed from the underside of the frame, illustrating the accessibility provided by the insert to internal components and electronic elements housed beneath the photovoltaic laminate;

FIG. 16 presents a bottom view of the photovoltaic roofing apparatus with the access insert fully seated and fastened within the frame, illustrating the closed configuration and secure attachment of the insert using mechanical fasteners positioned along the perimeter;

FIG. 17 presents a rear view of the photovoltaic roofing apparatus with electrical wiring shown in a folded shipping configuration, illustrating how the wires are routed into the notched regions of the crossmember to minimize bulk and reduce the risk of damage during transport;

FIG. 18A presents an exploded view of an access tile of the photovoltaic roofing apparatus, illustrating depth gauges, pilot holes, screw holes, and slotted mounting features associated with a removable access panel;

FIG. 18B presents an assembled view of the access tile of FIG. 18A, illustrating the removable access panel secured relative to the unitary support structure and covering an internal access region of the photovoltaic roofing apparatus;

FIG. 19 presents a top and side view of an eave closure, illustrating a plurality of weep holes positioned along the eave closure to provide drainage from the photovoltaic roofing apparatus;

FIG. 20A presents a close view of an eave closure, illustrating a centering notch configured to align the photovoltaic roofing apparatus relative to a centerline of a roofing substrate;

FIG. 20B presents a medium-distance view of the eave closure, illustrating a plurality of centering notches spaced along the eave closure to permit selective alignment of adjacent rows of photovoltaic roofing apparatuses relative to a roof centerline;

FIG. 21 presents a bottom perspective view of the eave closure, illustrating a plurality of centering notches and weep holes positioned along the eave closure for drainage, starter-bracket spacing, and roof alignment during installation;

FIG. 22 presents a bonding layout view of the photovoltaic roofing apparatus, illustrating the size, spacing, and placement of adhesive bonding material along structural bonding lands and crossmember stitch zones for securing a photovoltaic laminate to the support frame;

FIG. 23 presents a top view of the photovoltaic roofing apparatus, illustrating an edge seal region extending around a perimeter of the photovoltaic laminate for receiving a sealant separate from the adhesive bonding material;

FIG. 24 presents a bottom view of the photovoltaic roofing apparatus, illustrating sealing regions positioned along the underside of the support frame and around internal bonding regions to define a sealant path separate from the adhesive bonding material and directing water toward drainage locations; and

FIG. 25 presents a front view of the photovoltaic roofing apparatus, illustrating glass anchors molded into the unitary support structure and configured to retain the photovoltaic laminate without sliding insertion.

Like reference numerals refer to like parts throughout the several views of the drawings.

### DETAILED DESCRIPTION OF THE PREFERRED EMBODIMENT

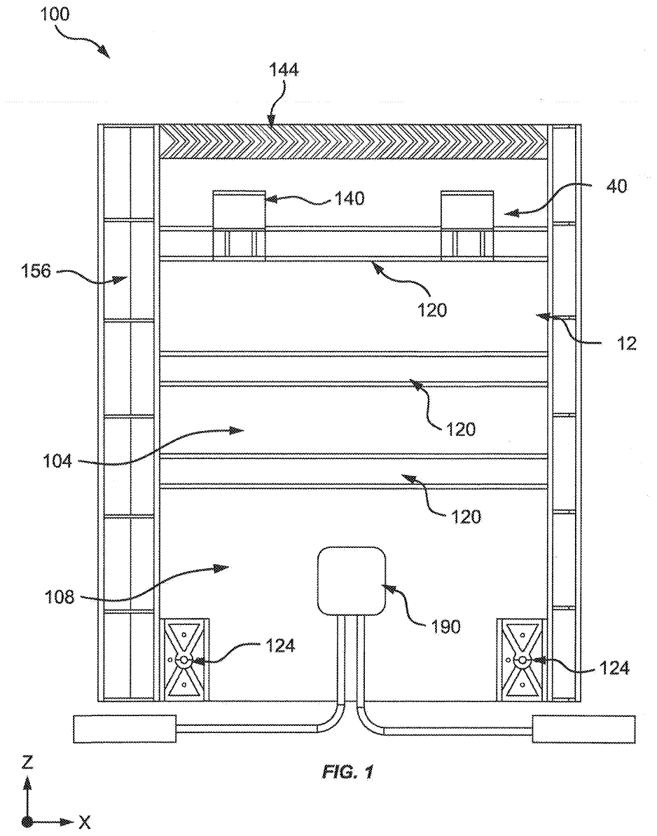

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

As shown throughout the figures, the present invention is directed to a photovoltaic roofing apparatus 100 designed to improve the attachment, installation, and structural integrity of solar roof tiles. The apparatus 100 integrates seamlessly with a glass sandwich of photovoltaic tiles 104, providing a single, injection-molded structure that includes preferred components such as a rain gutter system for tile locking, edge protection, protrusions for fastening, hooks for securing the tiles, a network of bracing for stability, and a double ventilation baffle for improved airflow and fire resistance. This innovative design simplifies the installation process, enhances durability, and ensures reliable performance in various environmental conditions, as illustrated in FIG. 1.

The photovoltaic tile 104 includes a photovoltaic cell encapsulated within a laminate structure 108. The laminate structure 108, as shown in FIG. 1, consists of layers of glass, ethylene-vinyl acetate (EVA) foil, silicon wafers, EVA foil, and a back sheet. A glass layer 112 is tempered for enhanced durability, and a back sheet 116 is made of a composite material for improved fire resistance. This configuration provides robust protection for the photovoltaic cells while maintaining the overall structural integrity of the tile 104. The tempered glass layer 112 ensures that the tile 104 can withstand various environmental conditions without compromising performance.

A unitary support structure 120 is integrally formed with the photovoltaic tile 104. The support structure 120 may comprise a fastening mechanism 124 configured to secure the photovoltaic tile 104 to a roofing substrate 128. The fastening mechanism 124 may include protrusions 132 that receive connectors, such as screws, for secure attachment. This design, depicted in FIG. 1, ensures that the tiles 104 are firmly held in place, even in adverse weather conditions, thereby enhancing the overall stability of the roofing system. The use of protrusions 132 simplifies the installation process and reduces the need for additional hardware. Additionally, this mechanism may provide a secure and reliable method for fastening the tiles, which is important for maintaining the integrity of the roofing system over time. To that end, a junction box 190 is also included.

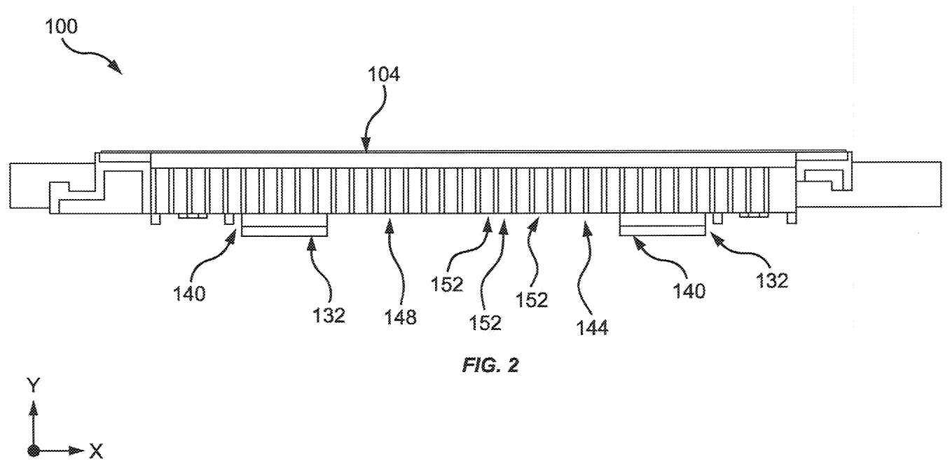

An interlocking mechanism 136 is designed to engage with adjacent photovoltaic tiles 104, forming a continuous and stable roofing surface. As depicted in FIG. 2, the interlocking mechanism 136 may comprise hooks 140 that engage with corresponding features on adjacent tiles. These hooks 140 allow for adjustment of the exposure of the photovoltaic tile 104 relative to adjacent tiles, ensuring a uniform and aesthetically pleasing appearance. This feature also provides flexibility during installation, accommodating various roof shapes and sizes. The ability to adjust the exposure of the tiles 104 allows for a more customized installation process, which can be particularly useful in achieving a precise and seamless fit on complex roofing structures.

A ventilation feature 144, illustrated in FIG. 2, is designed to allow airflow beneath the photovoltaic tile 104, enhancing cooling and preventing moisture accumulation. The ventilation feature 144 may comprise a double baffle system 148 with staggered openings 152 to enhance airflow and cooling efficiency while preventing the passage of fire. This configuration not only improves the efficiency of the photovoltaic cells but also enhances the fire resistance of the roofing system, providing a safer and more reliable solution. The staggered openings 152 ensure that airflow is maximized while minimizing the risk of fire spreading through the roofing system. Moreover, the design of the double baffle system 148 is such that it optimizes the balance between ventilation and protection, ensuring that the system remains both efficient and secure.

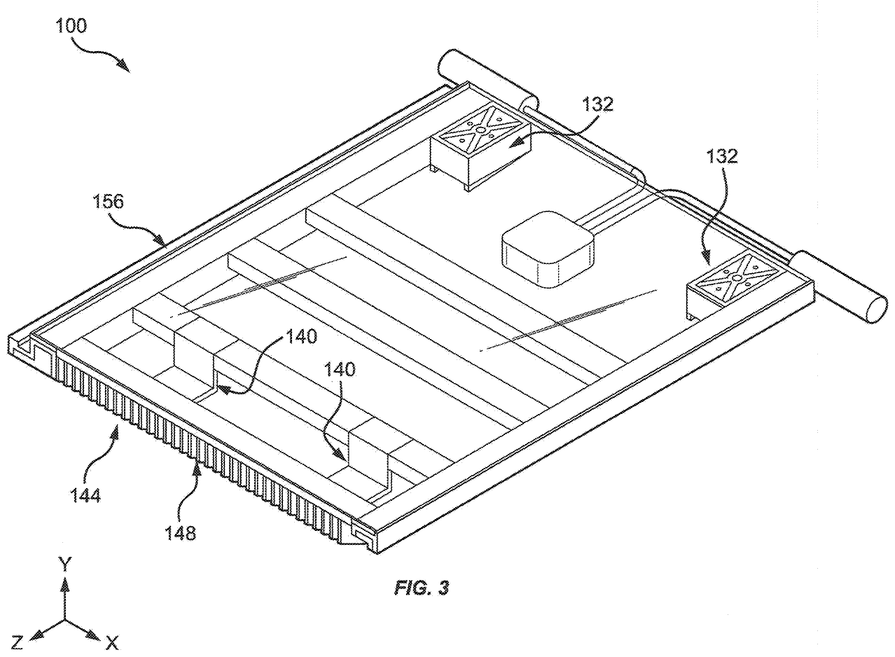

Edge protection 156 is integrated into the unitary support structure 120 to protect the exposed edges of the photovoltaic tile 104, as shown in FIG. 3. The edge protection 156 includes raised ridges or flanges 160 that prevent damage to the edges of the photovoltaic tile 104, ensuring longevity and durability. This feature is particularly important in preventing wear and tear over time, maintaining the integrity of the roofing system. The raised ridges or flanges 160 provide an additional layer of protection against environmental damage. In addition, this edge protection feature 156 ensures that the edges of the tiles 104 remain intact and secure, which is crucial for the overall longevity and performance of the roofing system.

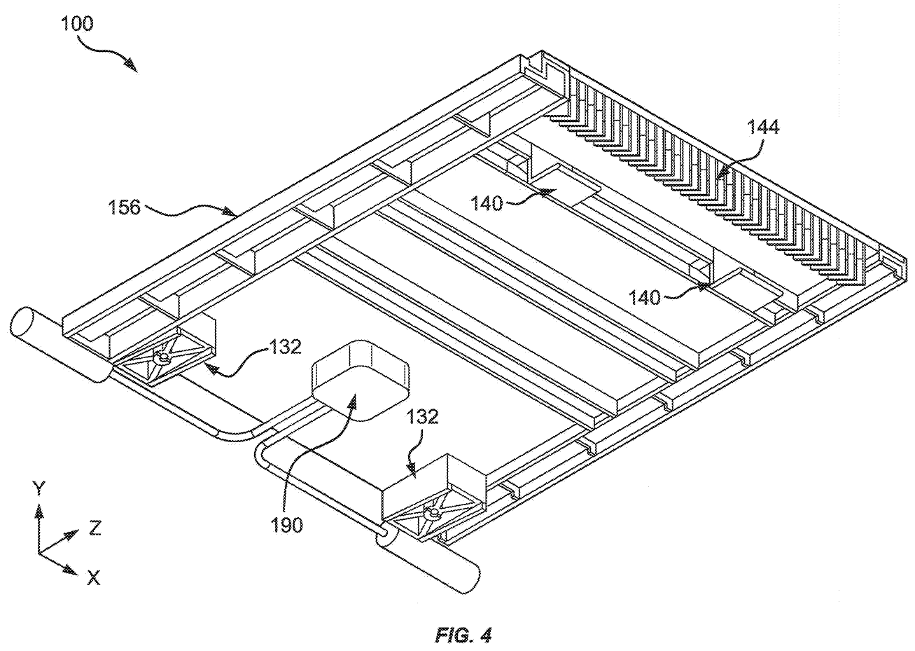

The unitary support structure 120 is made of a composite material 164 that provides enhanced fire resistance compared to conventional materials. As illustrated in FIG. 4, the composite material 164 includes fire-retardant additives 168 that further improve the fire resistance of the roofing apparatus 100. This material choice not only enhances safety but also contributes to the overall durability and performance of the photovoltaic roofing system. The fire-retardant additives 168 ensure that the material 164 can withstand high temperatures without degrading. This composite material 164, with its advanced fire-resistant properties, significantly enhances the safety and reliability of the roofing system, making it suitable for use in various environments, including those with higher fire risk.

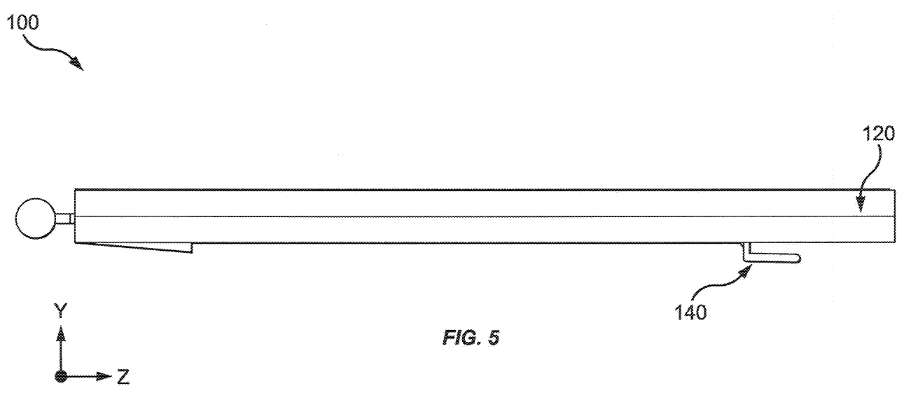

The alignment features 172 of the unitary support structure 120 ensure proper placement and spacing of adjacent photovoltaic tiles 104. FIG. 5 shows that the alignment features 172 include notches or grooves 176 that align with corresponding elements on adjacent tiles, facilitating self-alignment during installation. This design simplifies the installation process, reducing labor costs and installation time, and ensuring a consistent and professional finish. The notches or grooves 176 ensure that the tiles 104 are properly aligned, enhancing the structural integrity of the roofing system. By enabling precise and easy alignment, these features 172 help to maintain the aesthetic and functional quality of the roofing system over the long term.

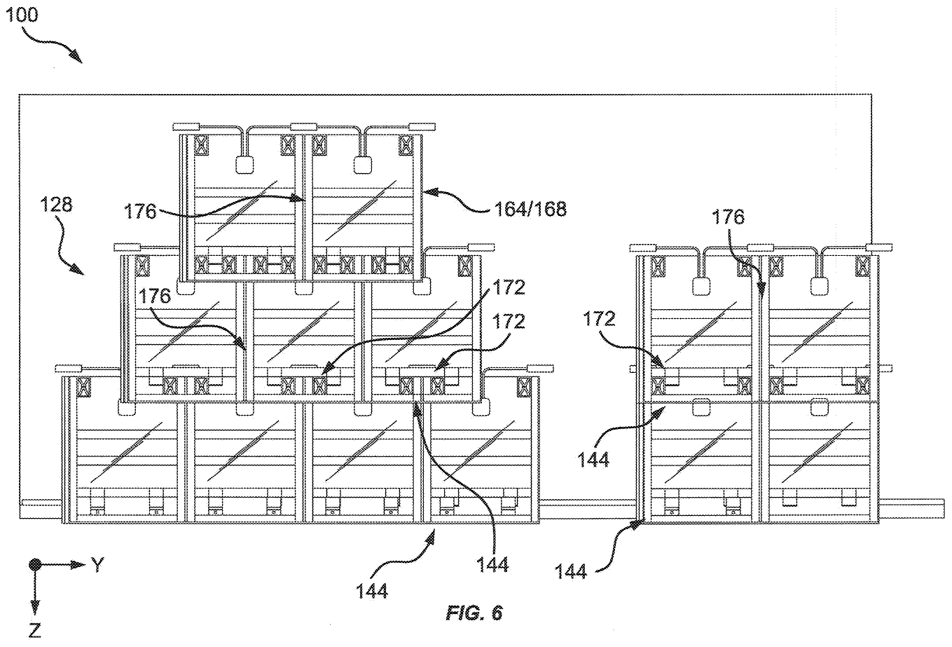

The ventilation feature 144, positioned at the lower edge of the photovoltaic tile 104, facilitates upward airflow, as depicted in FIG. 6. This positioning allows for effective cooling of the photovoltaic cells, preventing overheating and ensuring optimal performance. Additionally, the ventilation feature 144 acts as a barrier to wind-driven rain and snow, enhancing the environmental durability of the roofing system. The strategic placement of the ventilation feature 144 ensures that airflow is maximized without compromising the integrity of the roofing system. This dual function of providing ventilation while preventing water ingress is important for maintaining the performance and durability of the photovoltaic roofing apparatus 100 in various weather conditions.

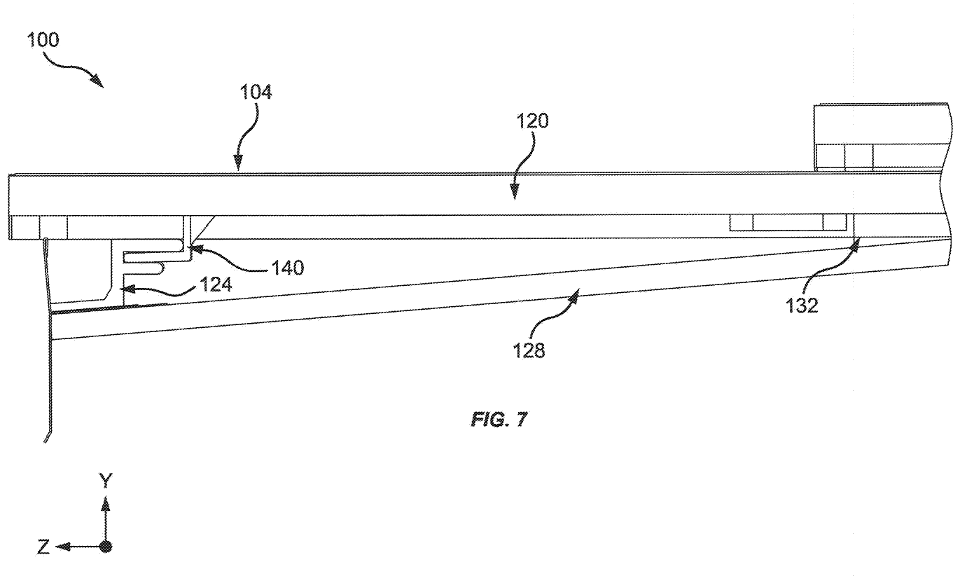

The method of installing the photovoltaic roofing apparatus 100 involves several key steps. First, a photovoltaic tile 104, including a photovoltaic cell encapsulated within a laminate structure 108 and a unitary support structure 120, is provided. The unitary support structure 120 comprises a fastening mechanism 124, an interlocking mechanism 136, and a ventilation feature 144. The photovoltaic tile 104 is then secured to a roofing substrate 128 using the fastening mechanism 124 of the unitary support structure 120. The interlocking mechanism 136 of the photovoltaic tile 104 is engaged with corresponding features on adjacent photovoltaic tiles, forming a continuous and stable roofing surface. Airflow beneath the photovoltaic tile 104 is allowed through the ventilation feature 144, enhancing cooling and preventing moisture accumulation. This method, illustrated in FIG. 7, simplifies installation, improves fire resistance, and provides enhanced structural stability to the photovoltaic tile 104. The entire process is designed to be efficient and straightforward, reducing the time and labor required for installation and ensuring a high-quality result.

The photovoltaic roofing apparatus 100 offers significant advantages over prior art by addressing several issues associated with existing solar roof tiles. By reducing the installation process to a single step and eliminating the need for multiple suppliers and components, the invention minimizes labor costs and installation time. The use of composite materials 164 enhances fire resistance, providing better protection against fire hazards. The exoskeleton's design allows for seamless integration with both solar and passive roof tiles, ensuring a uniform appearance and optimal performance. Additionally, the apparatus 100 improves wind resistance and environmental durability, ensuring that the tiles remain securely attached under various weather conditions. Overall, this innovative photovoltaic roofing apparatus 100 offers a more efficient, reliable, and cost-effective solution for integrating solar energy generation into building structures. The comprehensive benefits provided by the apparatus 100 make it an ideal choice for modern roofing applications, where efficiency, safety, and reliability are paramount.

The apparatus 100 also improves fire resistance in two ways. First, the composite materials 164 used to make the apparatus are more fire resistant than materials used in the prior art. Second, at the bottom of the apparatus 100, there is a double baffle 148 instead of a grid, as best shown in FIG. 8. This allows for sufficient airflow needed but deters fire from passing straight through. The baffle 148 is designed to maximize ventilation while preventing direct airflow, enhancing both cooling efficiency and fire resistance. The strategic design of the baffle 148 ensures that it provides maximum protection against fire while maintaining effective ventilation. This dual functionality is crucial for ensuring the safety and efficiency of the photovoltaic roofing apparatus 100.

The hooks 140 in the interlocking mechanism 136 are designed to allow the upper tile 104 to be pulled from the hook up to a ½ inch, enabling the installer to alter the exposure. This feature is particularly useful when a roof plane has an additional space at the top that needs to be adjusted. By dividing this space by the number of rows and stretching each exposure slightly, the installer can eliminate the need for an extra row of tiles, resulting in a more streamlined installation process. The adjustability of the hooks 140 provides flexibility during installation, accommodating various roof configurations. This feature not only simplifies the installation process but also enhances the aesthetic uniformity of the roofing system.

The photovoltaic roofing apparatus 100 can be utilized with composite passive tiles related to solar roof tiles, and any other composite tiles on the market could be improved with the fastening method on the apparatus 100. The photovoltaic roofing apparatus 100 can be made in any size to accommodate different sizes of glass sandwiches of tiles 104, making it adaptable to various roofing applications. It can also be made in an “S” tile style, where the pan of the “S” tile will be the area of the apparatus 100, and a glass sandwich 104 of two cells will fit in the pan. The versatility of the apparatus 100 ensures that it can be used in a wide range of roofing applications, providing a flexible solution for different roofing needs. This adaptability makes the apparatus 100 a valuable option for various architectural styles and requirements.

The alignment features 172, such as notches or grooves 176, ensure that the tiles 104 will self-align during installation. This feature reduces the need for precise manual alignment, speeding up the installation process and ensuring a consistent and professional finish. The alignment features 172 also help to maintain the structural integrity of the roofing system by ensuring that each tile is properly positioned and securely attached. The notches or grooves 176 provide a simple yet effective way to ensure that the tiles 104 are aligned correctly during installation. This self-alignment capability is particularly beneficial for large-scale installations, where efficiency and consistency are important.

The composite material 164 of the unitary support structure 120 provides enhanced fire resistance compared to conventional materials. The inclusion of fire-retardant additives 168 in the composite material 164 further improves its fire resistance, making the roofing system safer and more reliable. This material choice not only enhances safety but also contributes to the overall durability and performance of the photovoltaic roofing system. The fire-retardant additives 168 ensure that the composite material 164 can withstand high temperatures without degrading. The advanced fire-resistant properties of the composite material 164 make it an ideal choice for roofing applications in areas prone to wildfires or other fire hazards.

The photovoltaic roofing apparatus 100 is designed to be versatile and adaptable to various roofing applications. The unitary support structure 120 can be used with both solar and passive roof tiles, ensuring a seamless integration that maintains a uniform appearance and optimal performance. The apparatus 100 can be mounted directly to plywood or on an elevated batten/counter batten system, providing greater flexibility in construction methods and ensuring that the roofing system can be used in any installation situation. The adaptability of the apparatus 100 ensures that it can be used in a wide range of roofing applications. This versatility makes the apparatus 100 a valuable addition to any roofing project, offering flexibility and reliability.

The edge protection 156 integrated into the unitary support structure 120 protects the exposed edges of the photovoltaic tile 104, preventing damage and ensuring longevity. The raised ridges or flanges 160 of the edge protection 156 prevent damage to the edges of the photovoltaic tile 104, maintaining the integrity of the roofing system. This feature is particularly important in preventing wear and tear over time, ensuring that the roofing system remains durable and effective. The edge protection 156 provides an additional layer of protection against environmental damage. By safeguarding the edges of the tiles 104, this feature contributes to the overall durability and performance of the roofing system.

As best shown in FIG. 8, the ventilation feature 144 of the photovoltaic roofing apparatus 100 is positioned at the lower edge of the photovoltaic tile 104 to facilitate upward airflow. This positioning allows for effective cooling of the photovoltaic cells, preventing overheating and ensuring optimal performance. Additionally, the ventilation feature 144 acts as a barrier to wind-driven rain and snow, enhancing the environmental durability of the roofing system. The strategic placement of the ventilation feature 144 ensures that airflow is maximized without compromising the integrity of the roofing system. This dual function of providing ventilation while preventing water ingress is important for maintaining the performance and durability of the photovoltaic roofing apparatus 100 in various weather conditions.

The photovoltaic roofing apparatus 100 is designed to be easy to install, with features that simplify the installation process and reduce labor costs. The fastening mechanism 124, interlocking mechanism 136, and alignment features 172 work together to ensure a quick and efficient installation. The use of composite materials 164 and fire-retardant additives 168 enhances the safety and durability of the roofing system, making it a reliable and cost-effective solution for integrating solar energy generation into building structures. The design of the apparatus 100 ensures that it can be installed quickly and easily, reducing installation time and labor costs. This efficiency in installation is a significant advantage for both residential and commercial applications.

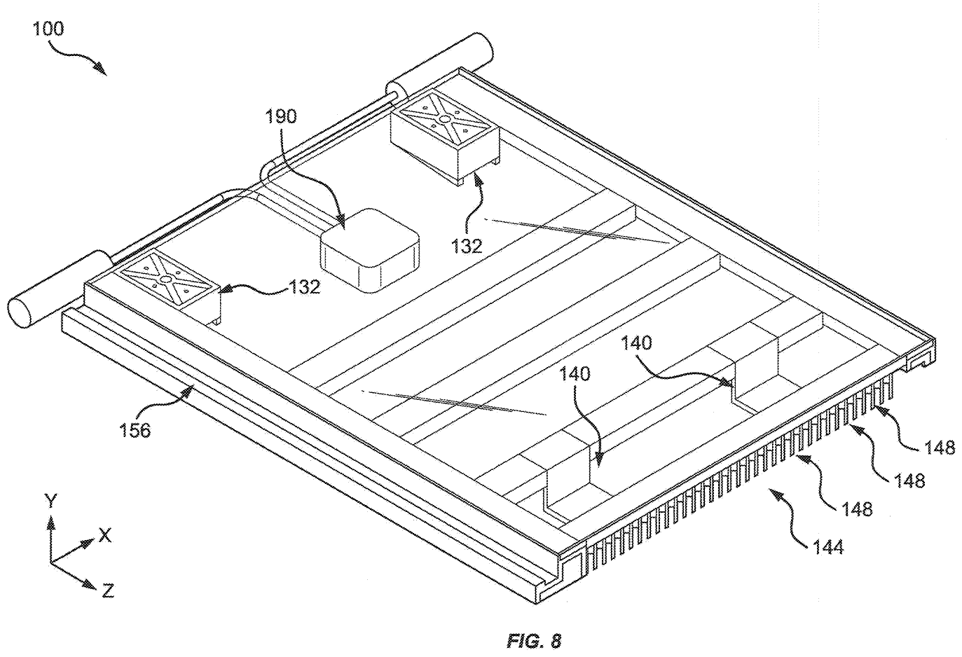

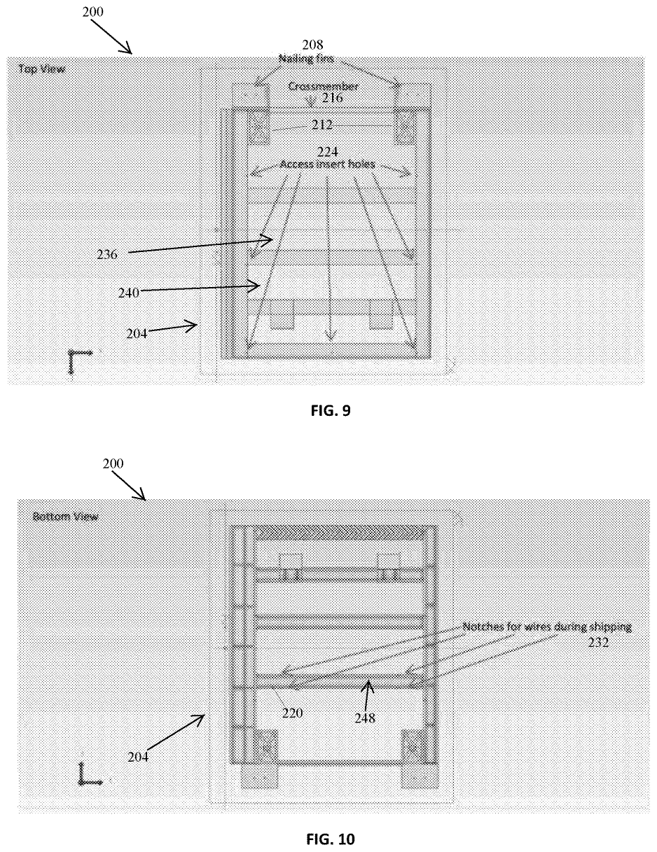

Referring now to FIGS. 9-17, another embodiment of the photovoltaic roofing apparatus 200 is illustrated. In this embodiment, additional structural and functional features are integrated into the unitary support structure 204 to facilitate installation, packaging, serviceability, and broader compatibility with photovoltaic technologies. These enhancements include a flange-style nailing fin 208, a series of structural braces 212, multiple crossmembers including an upper crossmember 216 and a wiring retention crossmember 220, access insert holes 224, a removable access insert 228, and routing accommodations for folded electrical wiring. Each of these features is designed to address practical challenges faced during transportation, installation, and field maintenance of photovoltaic systems. This embodiment is compatible with multiple laminate technologies, enabling greater flexibility for solar system integrators.

As shown in FIG. 9, the photovoltaic roofing apparatus 200 includes a frame 204 having a generally rectangular configuration and configured to support a photovoltaic tile 236 (shown in previous figures, e.g., FIG. 1). Extending from the upper edge of the frame 204 is an optional nailing fin 208. The nailing fin 208 provides an upper fastening surface through which one or more roofing nails may be driven to secure the apparatus 200 to a roofing substrate. The nailing fin 208 facilitates quick attachment using standard roofing tools, reducing labor time during installation. A plurality of access insert holes 224 is also visible in FIG. 9. These holes 224 are positioned to receive threaded fasteners or screws that removably secure an access insert 228 for servicing electronic components located beneath the laminate.

FIG. 10 illustrates the bottom side of the apparatus 200 and highlights the inclusion of recessed notches 232 formed within the wiring retention crossmember 220. These notches 232 are configured to receive and secure electrical wiring in a compact, folded configuration during packaging or shipment. By folding and nesting the wires into the notches 232, the risk of damage to the conductors during handling and transport is reduced. This wire retention structure helps prevent abrasion and tangling of the wiring, and further allows the apparatus to be stacked efficiently for bulk shipping. The notches 232 are positioned such that they align with lateral wiring channels and retain the conductors in a non-bulging profile.

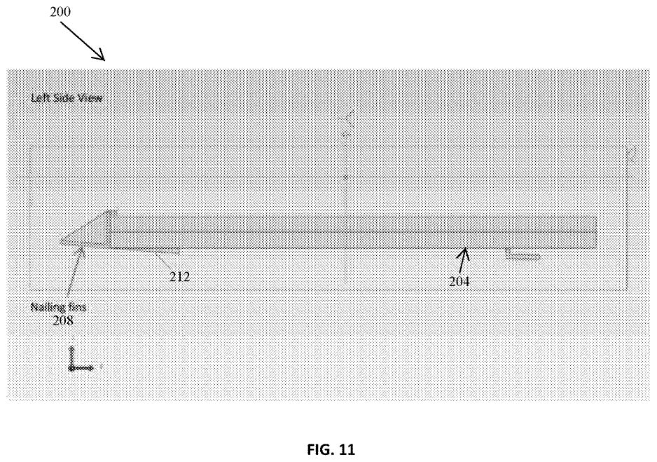

Turning to FIG. 11, a left side elevation of the apparatus 200 is shown. The flange-style nailing fin 208 extends upwardly from the top perimeter of the frame 204. This configuration allows traditional roofing nails to penetrate the fin 208 while leaving the body of the photovoltaic tile 236 undisturbed. The nailing fin 208 is integrally molded with the frame 204 and may optionally be composed of the same composite material. The profile of the nailing fin 208 provides a low-profile, reliable attachment surface that does not interfere with adjacent rows of photovoltaic tiles once installed.

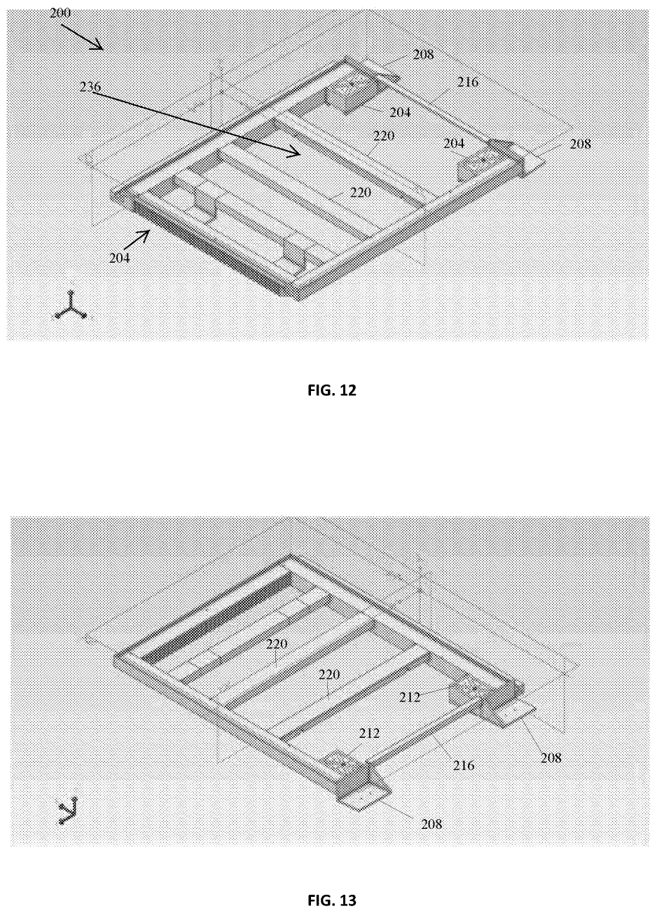

As shown in FIG. 12, a plurality of structural braces 212 are integrated between the nailing fin 208 and adjacent regions of the frame 204. These braces 212 are molded ribs or gussets that provide added mechanical rigidity to the nailing fin 208, preventing deflection or cracking during nailing. The braces 212 also distribute downward force exerted during the fastening process across a broader section of the frame 204. This improves long-term stability and minimizes stress concentrations at the corners of the apparatus. FIG. 12 further illustrates the overall isometric relationship between the nailing fin 208, braces 212, and crossmembers 216 and 220.

Referring to FIG. 13, the top crossmember 216 is shown extending laterally across the upper region of the frame 204. The top crossmember 216 is configured to absorb and distribute upward mechanical loads that may be imposed by overlapping or interlocking tiles above the apparatus 200. This reinforcement reduces the strain placed on adhesive bonds or laminate seams, thereby improving overall system durability. The presence of this crossmember improves wind uplift resistance by deflecting load forces away from weak points along the tile edges. The top crossmember 216 may be integrally molded with or mechanically coupled to the unitary support structure 204.

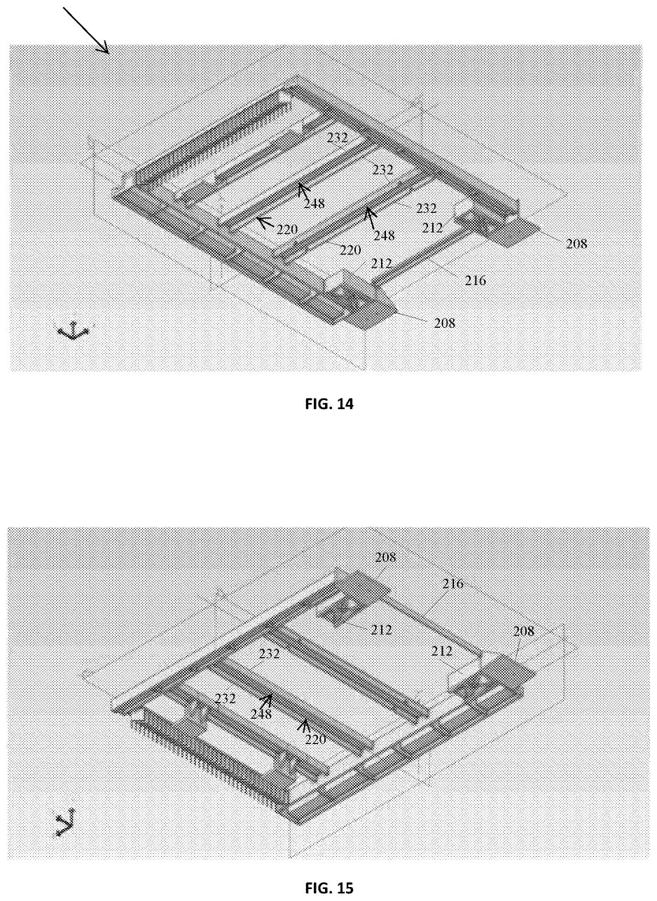

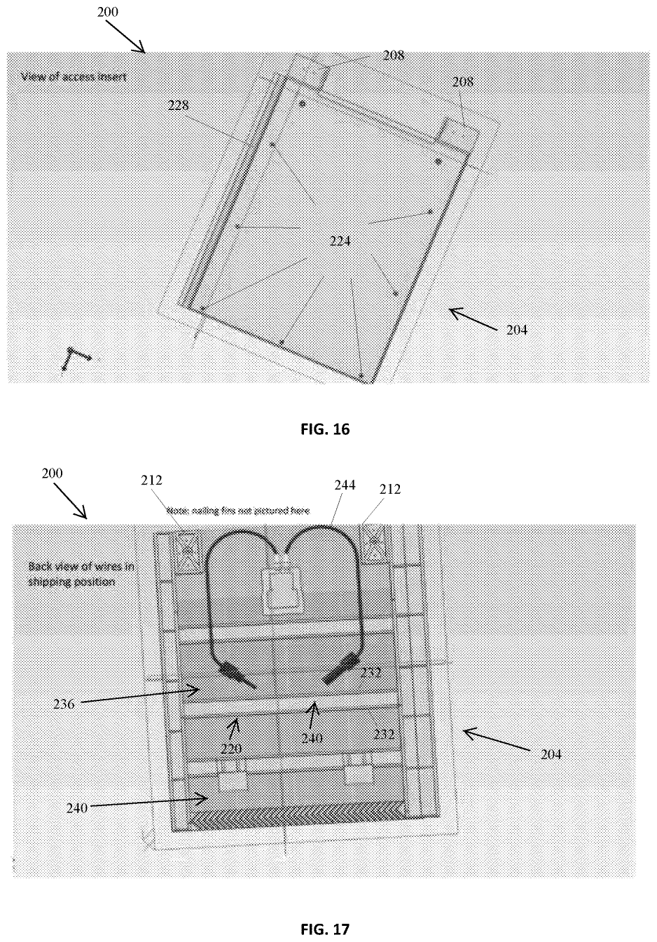

In FIG. 14, the underside of the apparatus 200 is depicted, showing seven access insert holes 224 evenly spaced around the central cavity. These holes 224 allow the access insert 228 (FIGS. 15 and 16) to be removably secured using screws or threaded fasteners. The holes 224 are molded through the support ribs of the frame 204 to align with the perimeter of the cavity defined beneath the photovoltaic tile 236. This configuration provides a serviceable interface for accessing internal components without disassembling the entire tile or removing the panel from the roof. It also enables component replacement in the field using basic tools.

FIG. 15 illustrates the access insert 228 in a partially removed configuration. The insert 228 is shaped to nest within a recessed opening on the bottom surface of the frame 204 and is held in place by fasteners received through the access insert holes 224. Removal of the insert 228 reveals an interior cavity 240 that may house a junction box, microinverter, wiring terminals, or other electronic components associated with the photovoltaic tile 236. This feature is particularly valuable for field service and diagnostics, allowing maintenance technicians to access electronics without disturbing roof sealing or mounting points. The insert 228 thus provides a convenient and non-destructive means of servicing internal components after installation.

In FIG. 16, the access insert 228 is shown fully installed and seated flush within the recessed cavity. The perimeter edges of the insert 228 align with the frame 204 and may include a sealing feature or gasket to prevent water ingress. The insert 228 may be composed of a thermoplastic, composite, or metal material, and may optionally include venting or labeling features. When installed, the insert 228 provides a low-profile cover that protects internal electronics while enabling future re-entry. Its configuration is compatible with manufacturing and service processes requiring access to embedded or replaceable electronics.

Referring now to FIG. 17, the photovoltaic roofing apparatus 200 is shown in a rear perspective view with electrical wiring 244 folded into the notches 232 of the wiring retention crossmember 220. This figure emphasizes the functionality of the notched structure in enabling neat, secure packaging of the apparatus 200 for shipping. The wiring 244 is retained within the frame 204 so that no elements protrude, thus reducing the risk of entanglement or stress damage during handling. Once installed, the wiring 244 may be unfolded and routed through external channels or into junction boxes as required. The notched retention system supports logistics and installation efficiency while protecting electrical components.

The unitary support structure 204, including the nailing fin 208, braces 212, crossmembers 216 and 220, and insert 228, may be formed from a composite material 248 incorporating one or more fire-retardant additives 252. This material selection improves the fire-resistance performance of the photovoltaic roofing apparatus 200. The structural components may be injection molded or formed using compression molding, extrusion, or similar fabrication techniques suitable for composite parts. The use of fire-retardant additives 252 may help meet building code requirements in jurisdictions with strict flammability standards. The composite formulation may also be tuned for environmental durability, UV resistance, and structural longevity.

The photovoltaic tile 236 supported by the apparatus 200 may be configured with various types of photovoltaic laminate technologies. In one embodiment, the laminate includes layers of tempered glass, encapsulant (e.g., EVA), crystalline silicon wafers, and a polymer back sheet. In alternative embodiments, the laminate may employ thin-film, bifacial, perovskite, or other emerging solar technologies. The unitary support structure 204 is configured to accommodate different laminate thicknesses and mounting geometries, thereby allowing manufacturers to produce a consistent frame while upgrading internal photovoltaic technology. This flexibility improves production scalability and future-proofing of the system.

The apparatus 200 may further include molded channels 256 adjacent to the recessed notches 232 to guide electrical wiring 244 during installation. These channels 256 assist with routing the conductors from the folded shipping configuration to a deployed, operational layout. The channels 256 may be open troughs or semi-enclosed conduits formed within or under the crossmember 220. They serve to reduce installer error and streamline the process of interconnecting the tile to a roof-mounted electrical system. In some implementations, the channels 256 may also serve as strain relief features, protecting terminal connections from tension loads.

The apparatus 200 may be installed using a simplified method. First, the photovoltaic roofing apparatus 200 is placed onto a roofing substrate such as plywood or battens. Roofing nails are inserted through the nailing fin 208 and into the substrate to secure the frame 204. Wiring 244 is routed into or from the recessed notches 232. The access insert 228 is optionally removed by disengaging fasteners from the insert holes 224 to permit inspection or connection of internal electrical components. Once connections are complete, the access insert 228 is replaced and secured flush within the frame 204.

The above-described structural features of the apparatus 200 facilitate ease of installation, shipping, and maintenance. The nailing fin 208 and associated braces 212 eliminate the need for separate attachment brackets. The crossmembers 216 and 220 reinforce structural stability while enabling intelligent wire management. The access insert 228 provides field-serviceable access to electronics without removing the panel. Collectively, these improvements provide a more versatile, durable, and installer-friendly photovoltaic roofing system.

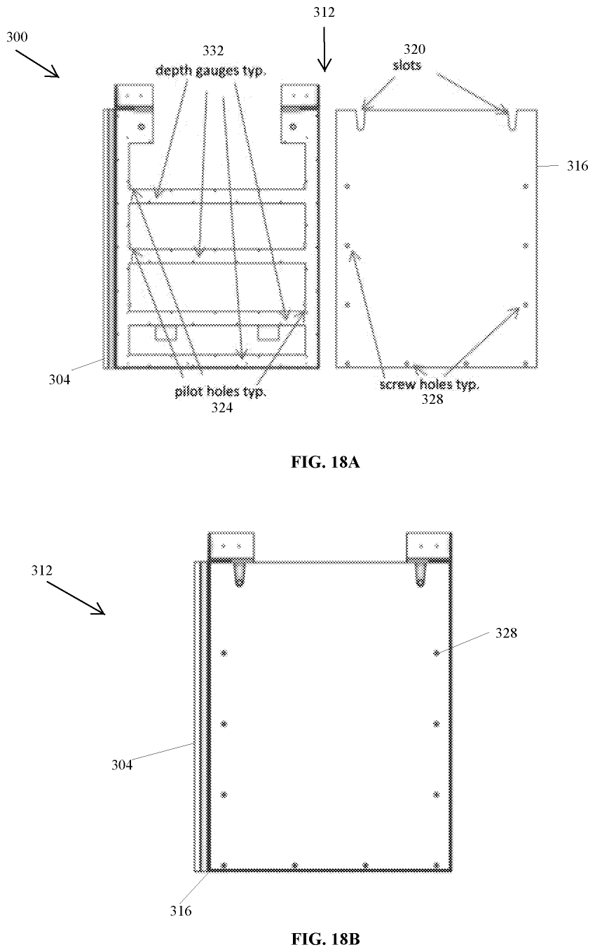

Referring now to FIGS. 18-25, another embodiment of the photovoltaic roofing apparatus 300 is illustrated. In this embodiment, additional structural and functional features are integrated into a unitary support structure 304 to facilitate bonding, sealing, drainage, impact resistance, field serviceability, and installation alignment. The photovoltaic roofing apparatus 300 may include a photovoltaic laminate 308 received by and supported relative to the unitary support structure 304. The unitary support structure 304 may be configured to provide a support frame for the photovoltaic laminate 308 while also defining bonding regions, sealing regions, drainage pathways, access features, and alignment features associated with installation of the photovoltaic roofing apparatus 300. These features may be implemented in connection with the structural frame arrangements described above, including the parent-frame structure and the additional features shown in FIGS. 9-17, or may be implemented in another photovoltaic roofing apparatus having a frame configured to receive a solar laminate, passive laminate, photovoltaic insert, or other roofing insert.

As shown in FIGS. 18A-B, the photovoltaic roofing apparatus 300 may include an access tile 312 configured to provide service access to one or more internal portions of the unitary support structure 304. The access tile 312 may include a removable access panel 316 that is configured to be secured to, released from, and moved relative to the unitary support structure 304. In the illustrated embodiment, the removable access panel 316 includes a plurality of slots 320 that are configured to receive fasteners while permitting the removable access panel 316 to slide relative to the unitary support structure 304 when the fasteners are loosened. The slots 320 therefore allow the removable access panel 316 to be removed or displaced without requiring complete removal of all associated fasteners, thereby improving serviceability of the photovoltaic roofing apparatus 300. In some embodiments, the removable access panel 316 may cover an internal cavity, wiring region, junction-box region, connector region, or other serviceable region positioned beneath or adjacent to the photovoltaic laminate 308.

With continued reference to FIG. 18, the access tile 312 may further include pilot holes 324 and screw holes 328 configured to guide and receive threaded fasteners, screws, or other mechanical connectors used to secure the removable access panel 316 to the unitary support structure 304. The pilot holes 324 may provide pre-positioned alignment points for fastener installation and may help reduce misalignment during assembly or field service. The screw holes 328 may be positioned to cooperate with corresponding fastener-receiving locations of the unitary support structure 304 such that the removable access panel 316 can be repeatedly removed and reinstalled. The arrangement of the slots 320, pilot holes 324, and screw holes 328 provides a serviceable access configuration that allows the removable access panel 316 to be loosened, shifted, and removed when access is needed. This configuration may be particularly useful where the photovoltaic roofing apparatus 300 includes electrical connectors, wiring components, junction boxes, bypass components, monitoring electronics, or other components that may require inspection or replacement after roof installation.

As further shown in FIG. 18, the unitary support structure 304 may include one or more depth gauges 332 positioned within or adjacent to a laminate-receiving region of the photovoltaic roofing apparatus 300. The depth gauges 332 may be configured as raised molded structures, ribs, bosses, stand-offs, lands, or other projections that establish a spacing between the photovoltaic laminate 308 and portions of the unitary support structure 304. The depth gauges 332 may help maintain a desired bond-line thickness when an adhesive bonding material is disposed between the photovoltaic laminate 308 and the unitary support structure 304. The depth gauges 332 may also help prevent excessive compression of adhesive tape, liquid adhesive, glue, sealant, or other bonding material during assembly of the photovoltaic roofing apparatus 300. In addition, the depth gauges 332 may provide localized support beneath the photovoltaic laminate 308 and may help cushion or resist direct impacts applied to the photovoltaic laminate 308, including impacts caused by hail, debris, installation handling, or maintenance activity.

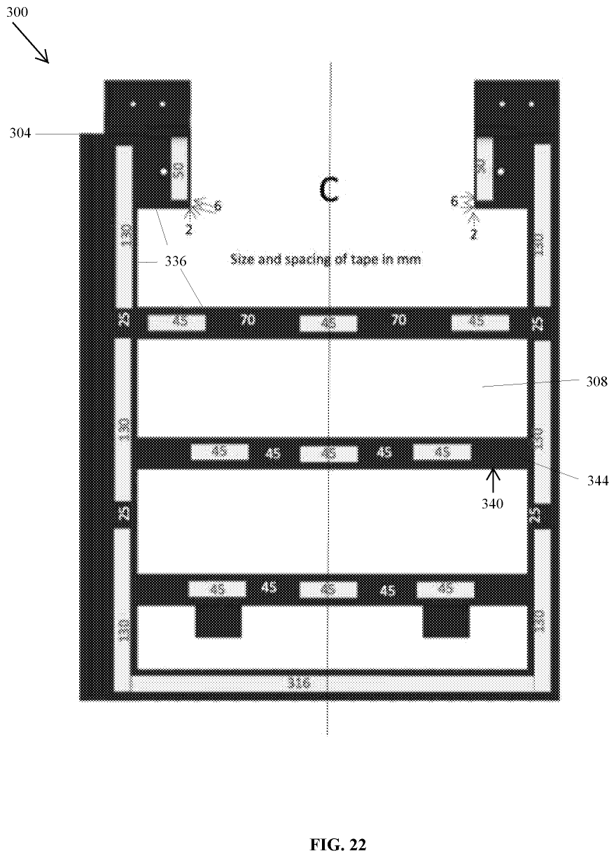

Referring now to FIG. 22, the photovoltaic roofing apparatus 300 may include a plurality of structural bonding lands 336 disposed along the unitary support structure 304. The structural bonding lands 336 may be configured to receive an adhesive bonding material 340 for securing the photovoltaic laminate 308 to the unitary support structure 304. In the illustrated embodiment, the adhesive bonding material 340 may be arranged in a pattern extending along side portions, bottom portions, top portions, and crossmember regions of the unitary support structure 304. The adhesive bonding material 340 may comprise double-sided adhesive tape, structural adhesive tape, foam tape, acrylic tape, liquid adhesive, glue, cured adhesive, or another bonding material suitable for securing a photovoltaic laminate or passive insert to a support frame. The illustrated bonding pattern distributes bonding forces across multiple regions of the unitary support structure 304 and may be configured to provide structural retention of the photovoltaic laminate 308 under wind uplift, thermal cycling, vibration, handling, and environmental loading.

With continued reference to FIG. 22, the structural bonding lands 336 may include crossmember stitch zones 344 positioned along crossmember regions of the unitary support structure 304. The crossmember stitch zones 344 may receive portions of the adhesive bonding material 340 to provide additional bonding support beneath central or intermediate portions of the photovoltaic laminate 308. The crossmember stitch zones 344 may cooperate with perimeter bonding regions to resist peel forces, shear forces, uplift forces, and relative movement between the photovoltaic laminate 308 and the unitary support structure 304. In some embodiments, the structural bonding lands 336 may be dimensioned and spaced to provide a selected total bond area corresponding to expected wind loads or design uplift pressures. The pattern shown in FIG. 22 is illustrative, and the adhesive bonding material 340 may be applied in different lengths, widths, thicknesses, patterns, and arrangements depending on the size of the photovoltaic laminate 308, the material of the unitary support structure 304, the adhesive selected, and the expected installation environment.

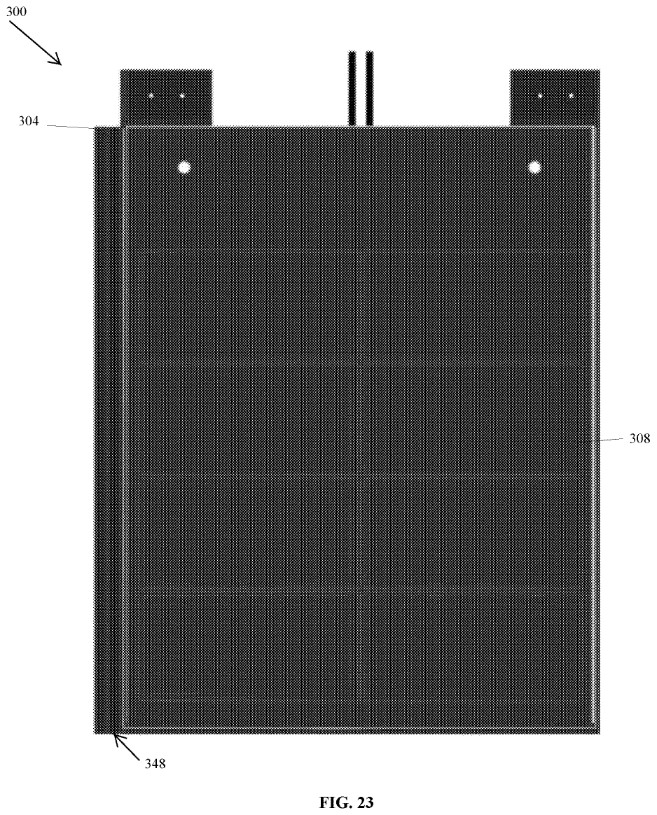

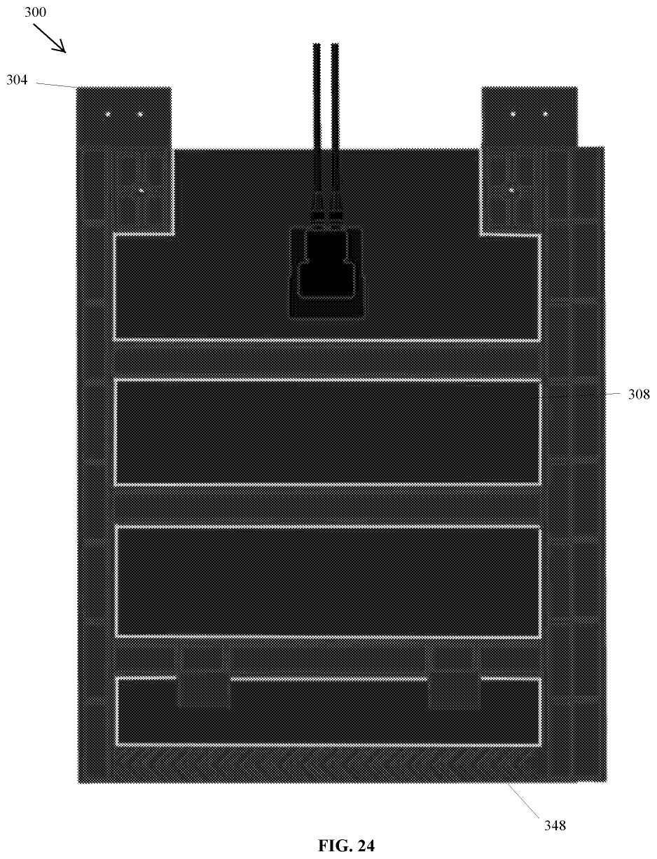

Referring now to FIGS. 23 and 24, the photovoltaic roofing apparatus 300 may further include an edge seal region 348 extending along at least a portion of a perimeter of the photovoltaic laminate 308. The edge seal region 348 may be configured to receive a sealant separate from the adhesive bonding material 340. As shown in FIG. 23, the edge seal region 348 may extend around an exposed perimeter of the photovoltaic laminate 308 to reduce water intrusion at the interface between the photovoltaic laminate 308 and the unitary support structure 304. As shown in FIG. 24, the edge seal region 348 may also extend along underside portions of the unitary support structure 304 or around interior regions adjacent to the photovoltaic laminate 308. The edge seal region 348 may receive silicone sealant, polymer sealant, moisture-resistant sealant, fire-resistant sealant, or another sealing material configured to reduce ingress of water, moisture, debris, or contaminants into the photovoltaic roofing apparatus 300.

As shown in FIGS. 22-24, the edge seal region 348 may be physically separated from the structural bonding lands 336 and the adhesive bonding material 340. This separation allows the adhesive bonding material 340 to serve primarily as a structural retention mechanism while the sealant applied along the edge seal region 348 serves primarily as an environmental barrier. In some embodiments, the structural bonding lands 336 may remain free of primer, sealant, or other materials that could interfere with the adhesive bonding material 340. In contrast, the edge seal region 348 may be treated, primed, or otherwise prepared to improve adhesion of the sealant to the unitary support structure 304 or to the photovoltaic laminate 308. By separating the adhesive bonding function from the sealing function, the photovoltaic roofing apparatus 300 may provide consistent bond-line performance while also providing a dedicated moisture barrier around the photovoltaic laminate 308.

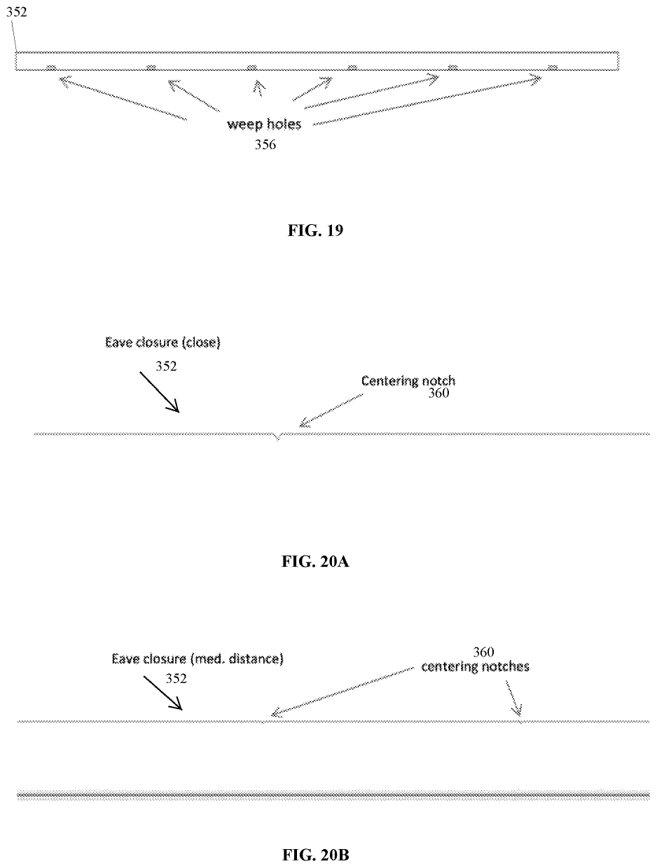

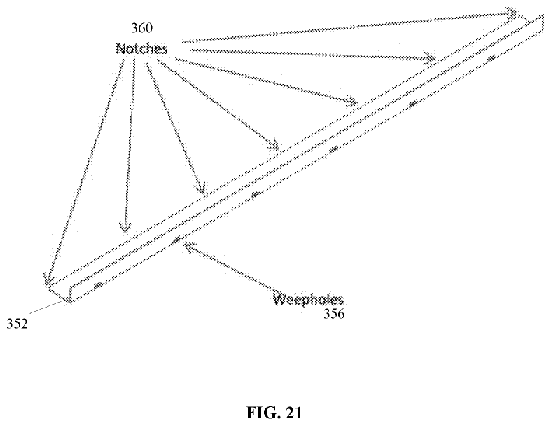

Referring now to FIGS. 19 and 21, the photovoltaic roofing apparatus 300 may be used with an eave closure 352 configured to be positioned along a lower edge of a roofing substrate, roof deck, starter row, or roof eave. The eave closure 352 may include a plurality of weep holes 356 spaced along a length of the eave closure 352. The weep holes 356 may allow water to escape from the photovoltaic roofing installation if water passes beyond the edge seal region 348 or otherwise enters a drainage path associated with the unitary support structure 304. The weep holes 356 may be positioned to facilitate gravity-assisted drainage from the roofing system and may reduce accumulation of water within or behind the photovoltaic roofing apparatus 300. In some embodiments, the weep holes 356 may also assist in locating starter brackets, spacing installation components, or defining drainage locations relative to one or more photovoltaic roofing apparatuses 300 installed above the eave closure 352.

As shown in FIGS. 20A, 20B, and 21, the eave closure 352 may further include one or more centering notches 360 configured to facilitate alignment of the photovoltaic roofing apparatus 300 during installation. FIG. 20A illustrates a close view of a centering notch 360, and FIG. 20B illustrates a plurality of centering notches 360 spaced along the eave closure 352. The centering notches 360 may be configured to align a tile, frame, joint, starter bracket, installation mark, chalk line, roof centerline, or other installation reference. In some embodiments, the centering notches 360 are spaced such that one centering notch 360 may be positioned on a centerline of a roof to center a photovoltaic roofing apparatus 300, while another centering notch 360 may be used to center a joint between adjacent photovoltaic roofing apparatuses 300 in an alternate row. This arrangement allows installers to establish row alignment with a reduced number of measurements and may improve placement consistency across a roof plane.

With continued reference to FIGS. 19-21, the eave closure 352 may be configured to provide both drainage and alignment functionality. The weep holes 356 may be positioned relative to starter-bracket locating regions so that starter brackets can be placed beside or between the weep holes 356 without blocking drainage. The centering notches 360 may provide visual, tactile, or mechanical reference points for positioning photovoltaic roofing apparatuses 300 relative to the eave closure 352. In some embodiments, the eave closure 352 may be installed before placement of the photovoltaic roofing apparatuses 300 and may serve as a starting reference for an initial course of tiles. The eave closure 352 may thereby provide a combined drainage, spacing, and alignment component that improves installation repeatability and reduces the likelihood of drainage obstruction at the lower edge of the roof.

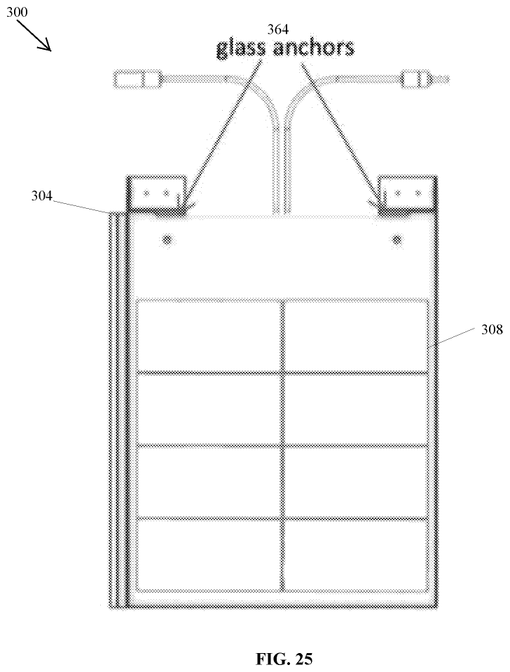

Referring now to FIG. 25, the photovoltaic roofing apparatus 300 may further include one or more glass anchors 364 associated with the unitary support structure 304 and configured to retain the photovoltaic laminate 308 relative to the unitary support structure 304. The glass anchors 364 may be molded in place within the unitary support structure 304 rather than being inserted through a sliding assembly operation. In some embodiments, the glass anchors 364 may be positioned adjacent to an upper region of the photovoltaic laminate 308, as shown in FIG. 25, to resist displacement of the photovoltaic laminate 308 relative to the unitary support structure 304. The glass anchors 364 may cooperate with the adhesive bonding material 340, the structural bonding lands 336, and the edge seal region 348 to maintain the photovoltaic laminate 308 in a retained position. The molded-in-place configuration of the glass anchors 364 may reduce assembly complexity, reduce tolerance stack-up, and provide a fixed retention point that is integrated into the unitary support structure 304.

The features shown in FIGS. 18-25 may be used individually or in combination with one another. For example, the adhesive bonding material 340 and structural bonding lands 336 shown in FIG. 22 may cooperate with the depth gauges 332 shown in FIG. 18 to control bond-line thickness when the photovoltaic laminate 308 is pressed into the laminate-receiving region of the unitary support structure 304. The edge seal region 348 shown in FIGS. 23 and 24 may cooperate with the weep holes 356 shown in FIGS. 19 and 21 so that water that passes beyond the perimeter seal can be routed toward a drainage location rather than remaining trapped within the assembly. The eave closure 352 and centering notches 360 shown in FIGS. 20A-21 may cooperate with the weep holes 356 to provide installation alignment while preserving drainage pathways. The access tile 312, removable access panel 316, slots 320, pilot holes 324, and screw holes 328 shown in FIG. 18 may provide a serviceable configuration that allows access to internal components after installation without requiring removal of the entire photovoltaic roofing apparatus 300 from the roof.

A method of assembling or installing the photovoltaic roofing apparatus 300 may include preparing the unitary support structure 304, applying the adhesive bonding material 340 to the structural bonding lands 336, positioning the photovoltaic laminate 308 relative to the unitary support structure 304, and compressing the photovoltaic laminate 308 toward the unitary support structure 304 until the depth gauges 332 establish a desired spacing between the photovoltaic laminate 308 and the unitary support structure 304. The method may further include applying a sealant along the edge seal region 348 after the photovoltaic laminate 308 has been bonded to the unitary support structure 304. The method may also include positioning the eave closure 352 along a roof eave, aligning one or more centering notches 360 relative to a roof centerline or other installation reference, and placing one or more photovoltaic roofing apparatuses 300 above the eave closure 352. The method may further include ensuring that the weep holes 356 remain unobstructed so that water entering past the edge seal region 348 can drain from the roofing installation. In embodiments including the access tile 312, the method may also include loosening fasteners associated with the slots 320 and sliding the removable access panel 316 relative to the unitary support structure 304 to provide service access to an internal cavity or electronic component region.

The photovoltaic roofing apparatus offers a comprehensive solution to the challenges faced by existing solar roof tiles. By simplifying the installation process, enhancing fire resistance, and improving environmental durability, the apparatus provides a more efficient, reliable, and cost-effective solution for integrating solar energy generation into building structures. This innovative design addresses the issues associated with existing solar roof tiles, offering significant advantages over prior art and setting a new standard in the photovoltaic roofing industry. The comprehensive design of the apparatus ensures that it meets the needs of modern roofing applications, providing a reliable and efficient solution for integrating solar energy generation into building structures.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is:

1. A photovoltaic roofing apparatus comprising:
a photovoltaic tile including a photovoltaic laminate;
a unitary support structure configured to support the photovoltaic tile, the unitary support structure comprising:
a support frame defining a laminate-receiving region configured to receive the photovoltaic laminate;
a plurality of structural bonding lands disposed along the support frame and configured to receive an adhesive bonding material between the support frame and the photovoltaic laminate;
one or more depth gauges extending from the support frame within the laminate-receiving region, the one or more depth gauges being configured to maintain a predetermined spacing between the photovoltaic laminate and the support frame while the adhesive bonding material is compressed therebetween;
an edge seal region extending along at least a portion of a perimeter of the photovoltaic laminate and configured to receive a sealant separate from the adhesive bonding material; and
at least one weep hole formed through a portion of the support frame and positioned to permit water entering past the edge seal region to drain from the unitary support structure;
wherein the adhesive bonding material, the one or more depth gauges, the edge seal region, and the at least one weep hole cooperate to secure the photovoltaic laminate to the support frame while controlling adhesive thickness and providing a drainage path for water intrusion.

2. The photovoltaic roofing apparatus of claim 1, wherein the adhesive bonding material comprises a double-sided structural adhesive tape positioned along the plurality of structural bonding lands.

3. The photovoltaic roofing apparatus of claim 2, wherein the double-sided structural adhesive tape extends along crossmember stitch zones of the support frame to provide additional bonding support beneath the photovoltaic laminate.

4. The photovoltaic roofing apparatus of claim 1, wherein the one or more depth gauges comprise raised molded bosses, ribs, or stand-off structures configured to maintain uniform adhesive thickness between the photovoltaic laminate and the support frame.

5. The photovoltaic roofing apparatus of claim 4, wherein the one or more depth gauges are further configured to cushion direct impacts applied to the photovoltaic laminate.

6. The photovoltaic roofing apparatus of claim 1, wherein the edge seal region is positioned outwardly from the plurality of structural bonding lands such that the sealant is physically separated from the adhesive bonding material.

7. The photovoltaic roofing apparatus of claim 6, wherein the edge seal region is configured to receive a silicone sealant extending continuously around a perimeter of the photovoltaic laminate.

8. The photovoltaic roofing apparatus of claim 1, wherein the at least one weep hole is positioned along a lower portion of the unitary support structure to permit gravity-assisted drainage of water entering past the edge seal region.

9. The photovoltaic roofing apparatus of claim 8, wherein the at least one weep hole is aligned with an eave closure configured to space starter brackets relative to the unitary support structure.

10. The photovoltaic roofing apparatus of claim 1, wherein the unitary support structure further comprises an eave closure including one or more centering notches configured to align the photovoltaic roofing apparatus relative to a roof centerline.

11. The photovoltaic roofing apparatus of claim 10, wherein the one or more centering notches are spaced such that adjacent rows of photovoltaic roofing apparatuses may be centered in alternating alignment patterns.

12. The photovoltaic roofing apparatus of claim 1, wherein the photovoltaic laminate is secured within the support frame by one or more glass anchors molded in place within the unitary support structure.

13. The photovoltaic roofing apparatus of claim 12, wherein the one or more glass anchors are fixed within the unitary support structure during formation of the support frame and are configured to retain the photovoltaic laminate without sliding insertion.

14. The photovoltaic roofing apparatus of claim 1, further comprising an access tile including a removable access panel configured to provide access to an internal cavity of the unitary support structure.

15. The photovoltaic roofing apparatus of claim 14, wherein the removable access panel comprises one or more slots configured to permit the access panel to be loosened and slid relative to the unitary support structure without complete removal of associated fasteners.

16. The photovoltaic roofing apparatus of claim 15, wherein the removable access panel is secured by threaded fasteners extending through the one or more slots into the unitary support structure.

17. The photovoltaic roofing apparatus of claim 1, wherein the photovoltaic laminate comprises a laminate selected from monocrystalline silicon, polycrystalline silicon, thin-film, or perovskite photovoltaic technologies.

18. The photovoltaic roofing apparatus of claim 17, wherein the unitary support structure is configured to support photovoltaic laminates having different thicknesses and material compositions.

19. A roofing alignment system for a photovoltaic roofing installation, the roofing
alignment system comprising:
an eave closure configured to be positioned along a lower edge of a roofing substrate;
a plurality of weep holes formed through the eave closure and spaced along a length of the eave closure to permit drainage from photovoltaic roofing apparatuses positioned above the eave closure;
a plurality of starter-bracket locating regions disposed along the eave closure and positioned relative to the plurality of weep holes to guide placement of starter brackets adjacent to, and spaced from, the plurality of weep holes; and
one or more centering notches formed along the eave closure and configured to align at least one photovoltaic roofing apparatus relative to a centerline of a roof;
wherein the plurality of weep holes, the plurality of starter-bracket locating regions, and the one or more centering notches cooperate to provide drainage, starter-bracket placement, and row-centering alignment during installation of the photovoltaic roofing apparatuses.

20. A serviceable photovoltaic roofing apparatus comprising:
a photovoltaic tile including a photovoltaic laminate;
a unitary support structure configured to support the photovoltaic tile, the unitary support structure defining an internal cavity beneath the photovoltaic laminate;
an access tile comprising a removable access panel configured to cover at least a portion of the internal cavity;
a plurality of fastener openings formed in the unitary support structure;
a plurality of slots formed in the removable access panel and configured to receive fasteners aligned with the plurality of fastener openings; and
a plurality of fasteners extending through the plurality of slots and into the plurality of fastener openings to removably secure the removable access panel to the unitary support structure;
wherein the plurality of slots are configured to permit the removable access panel to slide relative to the unitary support structure after the plurality of fasteners are loosened, thereby allowing the removable access panel to be removed from the unitary support structure to provide service access to the internal cavity.
